(19) United States
(12) Patent Application Publication
(10) Pub. No.: US 2016/0327794 A1
(43) Pub. Date: Nov. 10, 2016

(54) Helmet

(71) Applicant: BOE TECHNOLOGY GROUP CO., LTD., Beijing (CN)

(72) Inventors: Zhiqiang JIAO, Beijing (CN); Huaiting SHIH, Beijing (CN)

(21) Appl. No.: 15/094,412

(22) Filed: Apr. 8, 2016

(30) Foreign Application Priority Data
May 5, 2015 (CN) 201510223584.3

(51) Int. Cl. G02B 27/01; A42B 3/04; G01C 21/36; A42B 3/22; G06T 3/40; G06F 3/00

(52) U.S. Cl. CPC G02B 27/0172; G06T 3/40; G06F 3/005; G01C 21/3667; G01C 21/3697; A42B 3/22; A42B 3/0453; G02B 2027/013

(57) ABSTRACT

The embodiments of the invention refer to a technical field of daily supplies, and disclose a helmet, comprising a helmet body, which is provided with a wind shield, and the helmet further comprises: a velocity sensor for detecting the velocity; a display screen which is provided on the wind shield; a controller for transmitting the velocity information detected by the velocity sensor to the display screen for displaying. The helmet provided by the embodiment of the invention, by providing a display screen on the wind shield of the helmet worn by the rider, may display the riding velocity of the rider in real time in front of the eyes of the rider, and the rider is not needed to lower his head to look at the instrument, which improves driving safety.

### CROSS REFERENCE OF RELATED APPLICATION

The present application claims the benefit of Chinese Patent Application No. 201510223584.3, filed by May 5, 2015, the entire disclosure of which is incorporated herein by reference.

### TECHNICAL FIELD

The invention refers to a technical field of daily supplies, and specifically to a helmet.

### BACKGROUND

As increasing improvement of people's life level, outdoor sports is increasingly populated. Therein, bicycle riding is environmental and healthy, and thus becomes one of the main outdoor sports.

During riding, for safety, people would wear helmets. However, when the rider needs to know the current velocity of riding, he needs to lower his head to look at the velocity information displayed by the instrument board of the bicycle or other equipments. This goes against driving safety, and it is hard for the rider to know his driving velocity in real time.

### SUMMARY

An embodiment of the invention provides a helmet, which facilities the rider wearing the helmet knowing his riding velocity in real time, and improves riding safety.

For reaching the above object, embodiments of the invention provide the following technical solutions:

An embodiment of the invention provides a helmet, comprising a helmet body, which is provided with a wind shield, wherein, the helmet further comprises: a velocity sensor for detecting the velocity; a display screen which is provided on the wind shield; a controller for transmitting the velocity information detected by the velocity sensor to the display screen for displaying.

The helmet provided by the embodiment of the invention, by providing a display screen on the wind shield of the helmet worn by the rider, may display the riding velocity of the rider in real time in front of the eyes of the rider, and the rider is not needed to lower his head to look at the instrument, which improves riding safety.

In some optional embodiments, the display screen is located on the inside surface of the wind shield.

In some optional embodiments, the helmet further comprises: an alerting device; and the controller is further used for outputting an alert signal when the velocity received is larger than a maximum velocity preset; the alerting device is used for giving an alarm according to the alert signal.

The providing of the alerting device may reminds the rider not to overspeed constantly, further improving driving safety.

In some optional embodiments, the alerting device is a buzzer or a signal lamp.

In some optional embodiments, the controller is further used for making the font or image used for displaying velocity on the display screen to enlarge when the received velocity is larger than the maximum velocity. In another optional embodiment, the controller is further used for making the font or image used for displaying velocity on the display screen to blink. This can also function as alarming when the received velocity is larger than the maximum velocity.

In some optional embodiments, the helmet further comprises: a positioning module connecting to the controller, and the controller is further used for transferring position information detected by the positioning module to the display screen for displaying with corresponding map information. This facilitates the wearer knowing his position.

In some optional embodiments, the helmet further comprises: an optical imaging module located at a display surface side of the display screen, which optical imaging module is used for presenting the image displayed by the display screen within the view field of the user wearing the helmet. The providing of the optical imaging module further facilitates the user knowing the information such as his velocity and position, etc.

In some optional embodiments, the display screen is an OLED transparent display screen.

In some optional embodiments, the OLED transparent display screen is a monochrome display screen or a colorful display screen.

In some optional embodiments, the OLED transparent display screen is formed by a single display screen or is spliced by multiple display screens.

In some optional embodiments, the material of the underlying substrate of the OLED transparent display screen is an electric conduction glass or an electric conduction polymer.

### BRIEF DESCRIPTION OF FIGURES

The figures illustrated here are used for providing further understanding of the invention and constitute a part of the invention. The schematic embodiments of the invention and their descriptions are used for explaining the invention, and do not constitute improper limitation to the invention. In the figures:

FIG. 1 is a structure schematic view of a helmet provided by an embodiment of the invention;

FIG. 2 is a block diagram of an electronic system in the helmet provided by an embodiment of the invention.

### DETAIL EMBODIMENTS

The technical solutions of the embodiments of the invention will be described clearly and completely below in conjunction with the figures in the embodiments of the invention. Apparently, the embodiments described are only a part of the embodiments of the invention, rather than all of the embodiments. Based on the embodiments of the invention, all other embodiments obtained by those skilled in the art without creative effort are within the protection scope of the invention.

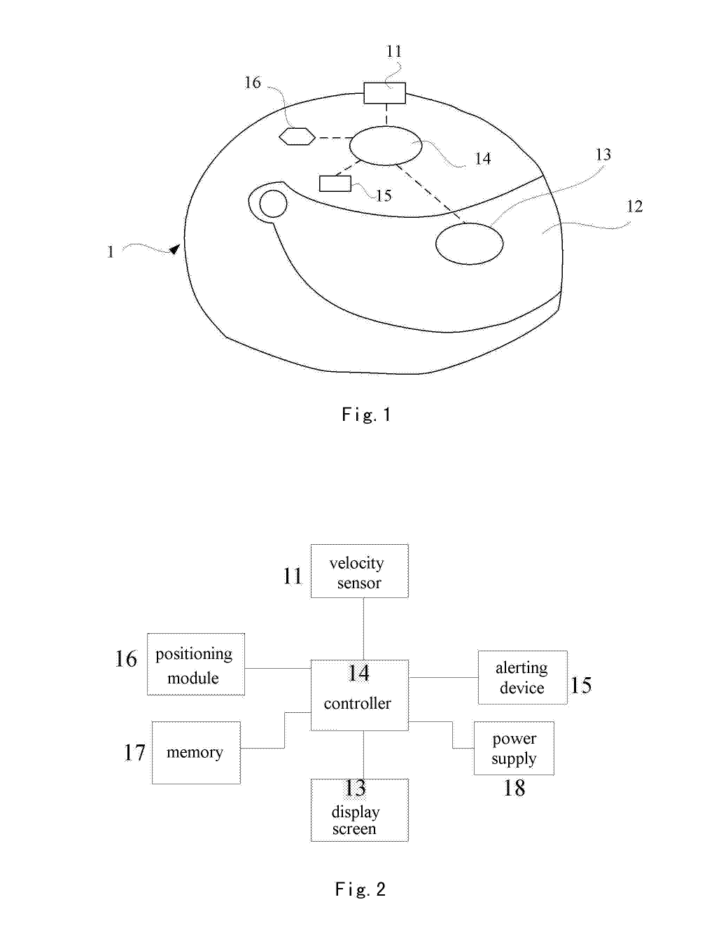

FIG. 1 is a structure schematic diagram of a helmet provided by the invention. FIG. 2 shows a block diagram of an electronic system in the helmet provided by the invention. As shown in FIGS. 1 and 2, the embodiment of the invention provides a helmet, comprising a helmet body 1, which is provided with a wind shield 12. The helmet further comprises: a velocity sensor 11 for detecting the velocity; a display screen 13 which is provided on the wind shield 12; a controller 14 connected to the velocity sensor 11 and the display screen 13 and used for transmitting the velocity information detected by the velocity sensor 11 to the display screen 13 for displaying.

The helmet provided by the embodiment of the invention, by providing a display screen on the wind shield of the helmet worn by the rider, can display the vehicle velocity of the rider in real time in front of the eyes of the rider, and the rider does not need to lower his head to see the instrument, which improves driving safety.

The velocity information detected above may be displayed by the display screen by ways of characters or pictures.

The display screen may be located on the inside surface of the wind shield or located on the outside surface of the wind shield. In a preferred embodiment, the display screen is located on the inside surface of the wind shield. And in a preferred embodiment, the wind shield can be opened upwards and closed downwards.

Further, the helmet further comprises: an alerting device 15 connected to the controller 14. The controller 14 is further used for outputting an alert signal when the velocity received is larger than a maximum velocity preset; the alerting device 15 is used for giving an alarm according to the alert signal. The providing of the alerting device 15 may constantly remind the rider not to overspeed, further improving driving safety. The maximum velocity preset may be set by the user according to the actual situation. Correspondingly, the helmet can be set with a button for adjusting the maximum velocity. The helmet may be set with a power supply 18 (such as a battery), so as to provide power for respective components.

The alerting device 15 is a buzzer or a signal lamp. The rider can be warned by sound or a blinking lamp of not riding too fast.

According to an alternative embodiment, the controller 14 is further used for making the font or image used for displaying velocity on the display screen to enlarge when the received velocity is larger than the maximum velocity, to function as alarming. According to another alternative embodiment, the controller 14 is further used for making the font or image used for displaying velocity on the display screen to blink when the received velocity is larger than the maximum velocity, to function as alarming.

For facilitating the rider to know his driving route and current position, please continue to refer to FIG. 1. The helmet further comprises: a positioning module 16 connecting to the controller 14, and the controller 14 is further used for transferring position information detected by the positioning module 16 and corresponding map information to the display screen for displaying. There are a memory 17 and a communication interface (not shown in the figure) connected to the controller 14. The map data can be stored in the memory 17.

For facilitating the rider to see the image displayed in the display screen in a better way, the helmet further comprises: an optical imaging module (not shown in the figure) located at a display surface side of the display screen 13, which optical imaging module is used for presenting the image displayed by the display screen within the view field of the user wearing the helmet. The optical imaging module is for example made of lens or lens group, and its light transmission direction is oriented towards human eyes, to present the image displayed by the display screen 13 on the human eyes. The optical imaging module can make the human eyes to see the content displayed on the display screen more easily.

The display screen may be an OLED transparent display screen, and certainly is not limited to the OLED transparent display screen.

Optionally, the OLED transparent display screen may be a monochrome display screen or a colorful display screen. The OLED transparent display screen may be formed by a single display screen or is spliced by multiple display screens.

The material of the underlying substrate of the OLED transparent display screen may have multiple options. In an optional embodiment, the material of the underlying substrate of the OLED transparent display screen is an electric conduction glass; in another optional embodiment, the material of the underlying substrate of the OLED transparent display screen is an electric conduction polymer. The different materials may be appliable to different application scenarios.

Obviously, those skilled in the art may make various changes and modifications to the invention without departing from the sprit and scope of the invention. As such, if these changes and modifications belong to the scope of the claims of the invention and the equivalent thereof, the invention is intended to include these changes and modifications. It should be noted that, the word “comprise” or “comprising” does not exclude presence of elements or steps that are not listed in the claims. The word “a” or “an” preceding an element does not exclude presence of a plurality of such elements. The mere fact that certain measures are recited in mutually different dependent claims does not indicate that a combination of these measures cannot be used to advantage. Any reference signs in the claims should not be construed as limiting the scope.

1. A helmet, comprising a helmet body, which is provided with a wind shield, wherein, the helmet further comprises:
a velocity sensor for detecting the velocity;
a display screen which is provided on the wind shield;
a controller for transmitting the velocity information detected by the velocity sensor to the display screen for displaying.

2. The helmet of claim 1, wherein the display screen is located on the inside surface of the wind shield.

3. The helmet of claim 1, wherein the helmet further comprises: an alerting device;
the controller is further used for outputting an alert signal when the velocity received is larger than a maximum velocity preset;
the alerting device is used for giving an alarm according to the alert signal.

4. The helmet of claim 3, wherein the alerting device is a buzzer or a signal lamp.

5. The helmet of claim 1, wherein the controller is further used for making the font or image used for displaying velocity on the display screen to enlarge when the received velocity is larger than the maximum velocity.

6. The helmet of claim 1, wherein the controller is further used for making the font or image used for displaying velocity on the display screen to blink when the received velocity is larger than the maximum velocity.

7. The helmet of claim 1, wherein the helmet further comprises: a positioning module connecting to the controller; and the controller is further used for transferring position information detected by the positioning module and corresponding map information to the display screen for displaying.

8. The helmet of claim 1, wherein the helmet further comprises: an optical imaging module located at a display surface side of the display screen, which optical imaging module is used for presenting the image displayed by the display screen within the view field of the user wearing the helmet.

9. The helmet of claim 2, wherein the helmet further comprises: an optical imaging module located at a display surface side of the display screen, which optical imaging module is used for presenting the image displayed by the display screen within the view field of the user wearing the helmet.

10. The helmet of claim 3, wherein the helmet further comprises: an optical imaging module located at a display surface side of the display screen, which optical imaging module is used for presenting the image displayed by the display screen within the view field of the user wearing the helmet.

11. The helmet of claim 4, wherein the helmet further comprises: an optical imaging module located at a display surface side of the display screen, which optical imaging module is used for presenting the image displayed by the display screen within the view field of the user wearing the helmet.

12. The helmet of claim 5, wherein the helmet further comprises: an optical imaging module located at a display surface side of the display screen, which optical imaging module is used for presenting the image displayed by the display screen within the view field of the user wearing the helmet.

13. The helmet of claim 1, wherein the display screen is an OLED transparent display screen.

14. The helmet of claim 13, wherein the OLED transparent display screen is a monochrome display screen or a colorful display screen.

15. The helmet of claim 14, wherein the OLED transparent display screen is formed by a single display screen or is spliced by multiple display screens.

16. The helmet of claim 14, wherein the material of the underlying substrate of the OLED transparent display screen is an electric conduction glass or an electric conduction polymer.
